(19) United States
(12) Patent Application Publication
(10) Pub. No.: US 2026/0141696 A1
(43) Pub. Date: May 21, 2026

(54) UNIFYING IMAGE AND VIDEO REGION-LEVEL UNDERSTANDING VIA TOKEN MARKS

(71) Applicant: NVIDIA Corporation, Santa Clara, CA (US)

(72) Inventors: Ryo Hachiuma, Taipei City (TW); Min-Hung Chen, Zhubei City (TW); Miran Heo, Seoul (KR); De-An Huang, Cupertino, CA (US); Sifei Liu, San Diego, CA (US); Subhashree Radhakrishnan, Milpitas, CA (US); Yu-Chiang Wang, Taipei City (TW)

(21) Appl. No.: 19/253,250

(22) Filed: Jun. 27, 2025

Related U.S. Application Data
(60) Provisional application No. 63/723,031, filed on Nov. 20, 2024.

(51) Int. Cl. G06V 10/774; G06V 10/776; G06V 10/82; G06V 20/40; G06V 20/70

(52) U.S. Cl. CPC G06V 10/7747; G06V 10/82; G06V 20/41; G06V 20/70; G06V 10/776

(57) ABSTRACT

Multimodal large language models (MLLMs) have evolved to interpret visual elements, progressing from text prompts for holistic image understanding to sophisticated approaches for region-level understanding. However, a key limitation of existing methods is the reliance on representations that may not consistently capture regions across frames, particularly when aiming for a unified solution for both images and videos. The present disclosure unifies image and video region-level understanding by an LLM via token marks.

### CLAIM OF PRIORITY

This application claims the benefit of U.S. Provisional Application No. 63/723,031 (Attorney Docket No. NVIDP1425+/24-TP-1586US01) titled “UNIFYING IMAGE AND VIDEO REGION-LEVEL UNDERSTANDING VIA TOKEN MARKS,” filed Nov. 20, 2024, the entire contents of which is incorporated herein by reference.

### TECHNICAL FIELD

The present disclosure relates to artificial intelligence processes for image understanding.

### BACKGROUND

Multimodal large language models (MLLMs) have evolved to interpret visual elements, progressing from text prompts for holistic image understanding to sophisticated approaches for region-level understanding. To achieve interactive region-specific comprehension in images, recent methods employ various strategies to represent target regions: encoding textual box coordinates within the text tokens, utilizing visual region of interest (Rol) features, or applying visual markers. Extending these capabilities to the video domain, some approaches incorporate initial frame bounding box coordinates as a textual form for the region-level video understanding tasks. Nonetheless, a general approach that effectively addresses region-specific tasks across both image and video remains an open challenge.

One key challenge in developing a solution is achieving scalability for video sequences. Since videos can contain a large number of frames, approaches that rely on bounding box coordinates as textual input face scaling limitations, as input region tokens increase linearly with the number of frames. Rol-based methods also encounter this issue, as they require repeated extraction of visual features from spatial regions. Relying on a single frame (e.g., the initial frame) as an alternative is also suboptimal, as it lacks a robust reference for the target across subsequent frames.

Another challenge is addressing the temporal drift issue. There is no standardized method for unifying the multiple vectors representing the same object across different frames (e.g., bounding boxes in each frame) into a single, consistent vector. Unlike in static images, this issue becomes particularly problematic in videos, as target objects often change in appearance across frames due to motion, scale shifts, and perspective changes. Consequently, merging Rol features into a single representation can introduce inconsistencies, resulting in a loss of essential visual details.

A key limitation of previous methods is the reliance on representations that may not consistently capture regions across frames, particularly when aiming for a unified solution for both images and videos. There is thus a need for addressing these issues and/or other issues associated with the prior art. For example, there is a need to provide unifying image and video region-level understanding via token marks.

### SUMMARY

A method, computer readable medium, and system are disclosed to train a large language model (LLM) to provide visual content region-level understanding. A dataset of prompt pairs for a visual content is accessed, where each of the prompt pairs includes a region prompt that defines a target region within the visual content and a text prompt that describes the target region within the visual content. A LLM is trained to provide visual content region-level understanding, using the dataset, including for each prompt pair of at least a subset of the prompt pairs included in the dataset: sampling a predefined token from a set of predefined tokens to represent the target region within the visual content, using the predefined token to form a correspondence between the target region within the visual content and the text prompt, and learning by the LLM an alignment between the target region within the visual content and the text prompt, based on the correspondence.

### BRIEF DESCRIPTION OF THE DRAWINGS

FIG. 1 illustrates a method for training LLM to provide visual content region-level understanding, in accordance with an embodiment.

FIG. 2 illustrates a system pipeline for training a LLM to provide visual content region-level understanding, in accordance with an embodiment.

FIG. 3 illustrates the temporal region guidance head of FIG. 2, in accordance with an embodiment.

FIG. 4 illustrates an instruction sample generation process, in accordance with an embodiment.

FIG. 5 illustrates a method for using an LLM to provide visual content region-level understanding, in accordance with an embodiment.

FIG. 6 illustrates a visual example of the input and output of the method of FIG. 5, in accordance with an embodiment.

FIG. 7A illustrates inference and/or training logic, according to at least one embodiment;

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

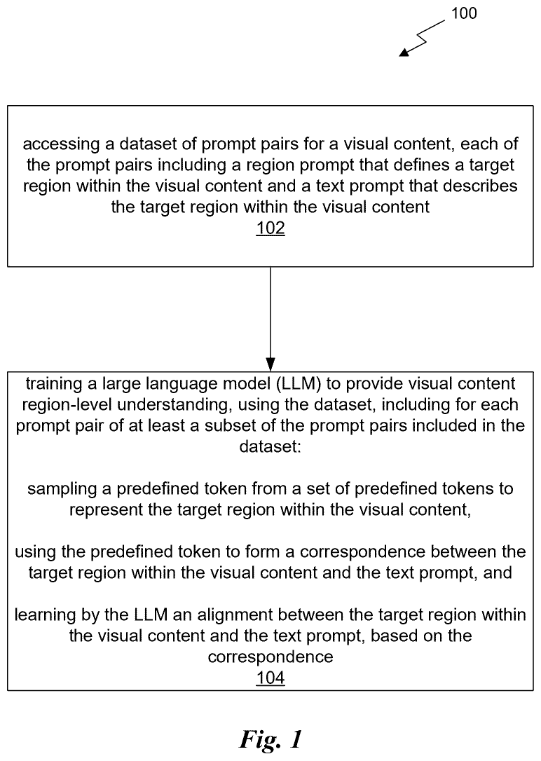

FIG. 1 illustrates a method 100 for training LLM to provide visual content region-level understanding, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a dataset of prompt pairs for a visual content is accessed, where each of the prompt pairs includes a region prompt that defines a target region within the visual content and a text prompt that describes the target region within the visual content. The dataset refers to a preconfigured set of prompt pairs, as described herein. The dataset may be accessed from a repository.

In embodiments, the visual content may be an image or a frame of a video. The prompt pairs for the visual content refer to pairs (i.e. sets of two) prompts with each pair comprised of a region prompt and a text prompt. The region prompt refers to an identifier of a target region within the visual content. The target region refers to any region (e.g. portion, area, etc.) within the visual content. In an embodiment, the region prompt may be a bounding box defining the target region within the visual content. In an embodiment, the region prompt may be a mask defining the target region within the visual content. The text prompt refers to a text that describes one or more features of the target region within the visual content. In an embodiment, the text prompt may include a single word or a single phrase or a combination of phrases. In an embodiment, the target region may correspond to a visual element (e.g. object) in the visual content and the text prompt may include at least one noun that names the visual element.

In operation 104, a LLM is trained to provide visual content region-level understanding, using the dataset, including for each prompt pair of at least a subset of the prompt pairs included in the dataset: sampling a predefined token from a set of predefined tokens to represent the target region within the visual content, using the predefined token to form a correspondence between the target region within the visual content and the text prompt, and learning by the LLM an alignment between the target region within the visual content and the text prompt, based on the correspondence.

With respect to the present description, the visual content region-level understanding refers to an understanding of a specified (i.e. prompted) region in a given visual content based on a given text prompt referring to the region. The understanding may be represented by a textual description of the region. For example, in an embodiment, the visual content region-level understanding may include the LLM understanding a visual element in a given visual content in response to a given text prompt referring to the visual element and a given region prompt defining the visual element.

As mentioned, the LLM is trained on each prompt pair by sampling a predefined token from a set of predefined tokens to represent the target region within the visual content, and further using the predefined token to form a correspondence between the target region within the visual content and the text prompt. The predefined tokens may be any preconfigured identifiers that are unique with respect to one another. In an embodiment, using the predefined token to form a correspondence between the target region within the visual content and the text prompt may include associating the predefined token with both the target region within the visual content and the text prompt. In an embodiment, associating the predefined token with the target region within the visual content may include embedding the predefined token into pixels included in the target region within the visual content. In an embodiment, associating the predefined token with the text prompt may include injecting the predefined token into the text prompt.

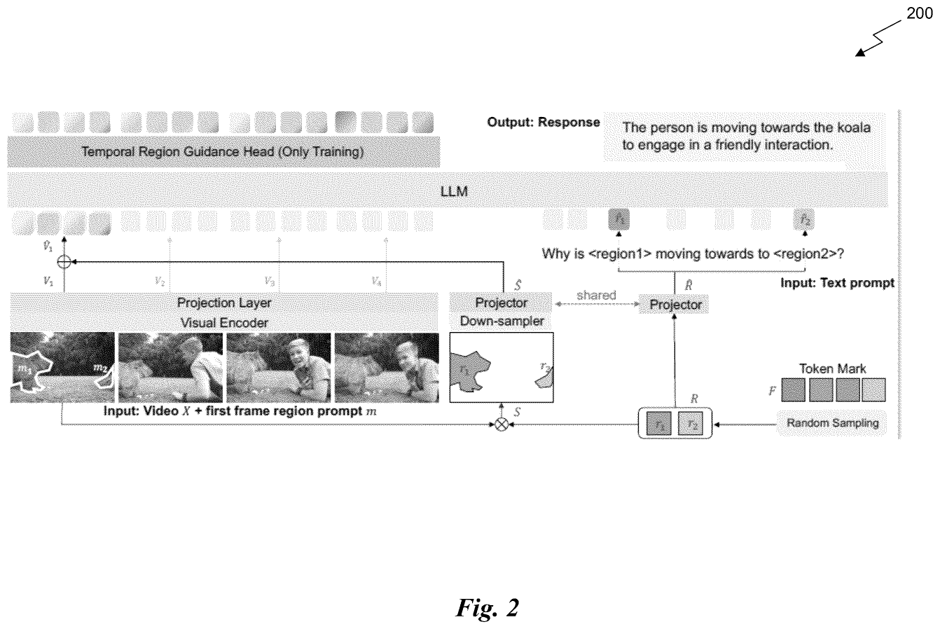

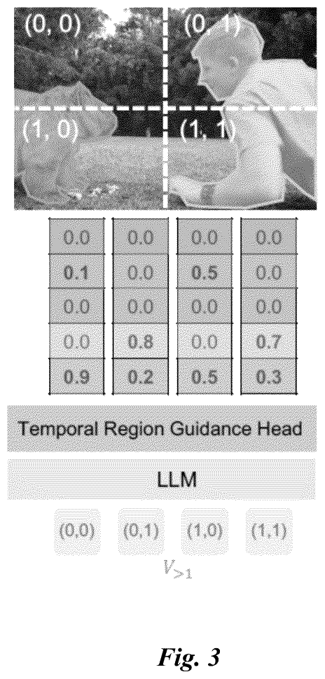

As also mentioned, the LLM is trained on each prompt pair by learning, by the LLM, an alignment between the target region within the visual content and the text prompt, based on the correspondence formed between the target region and the text prompt via the predefined token. Thus, a selected one of the tokens can be used to form a correspondence between the target region within the visual content and the text prompt, and such correspondence can then be used by the LLM to learn an alignment between the target region within the visual content and the text prompt. The alignment refers to a correlation between the target region and the text prompt. In an embodiment, when the visual content is a frame of video, then then training the LLM may further include generating region-aware predictions for a sequence of frames in the video. An embodiment of training the LLM will be described in more detail below with reference to FIGS. 2-3.

To this end, once trained per the method 100, the LLM may be used at inference time to provide region-level understanding of a visual content for any given region prompt and text prompt. For example, given a visual content with a corresponding region prompt and a command or question prompt input by a user, the trained LLM may generate a text response to the command/question as it pertains to the prompted region. In an embodiment, multiple region prompts for a visual content may be input to the LLM, each with a corresponding identifier, along with a text prompt that refers to the identifiers. In this embodiment, the LLM may generate a text response that refers to the multiple regions of the visual content.

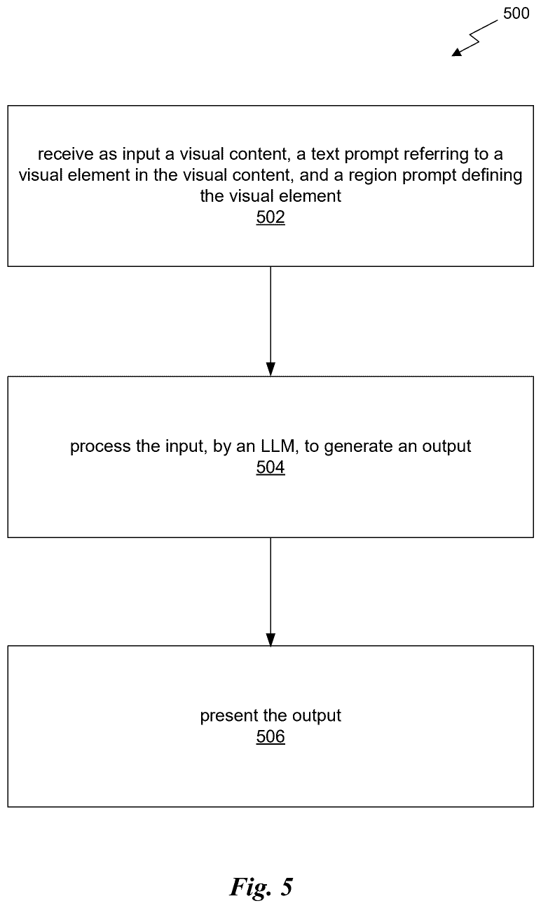

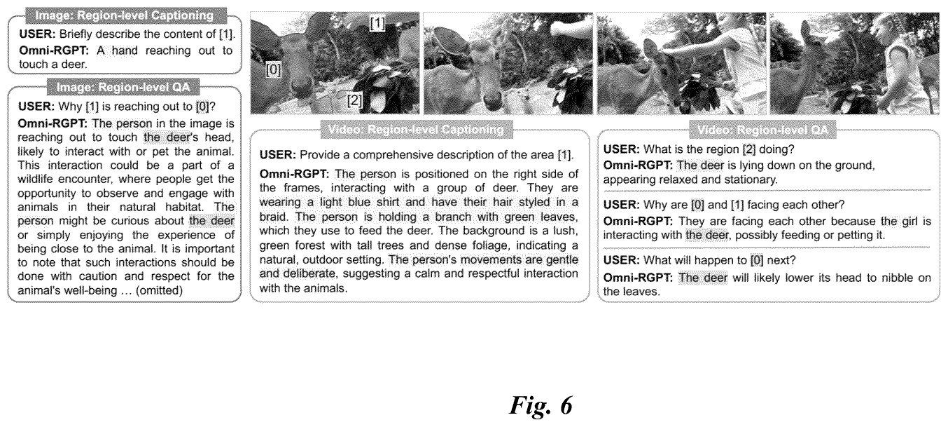

In an embodiment, the method 100 may further include deploying the trained LLM. In an embodiment, the trained LLM may be deployed to a cloud computing device for use by a plurality of users in providing region-level understanding of a visual content. In an embodiment, the trained LLM may be executed to textually describe a visual element in a given visual content in response to a given text prompt referring to the visual element and a given region prompt defining the visual element. In embodiments, the given visual content may be an image or a video. In an embodiment, the trained LLM is used for visual content captioning. In another embodiment, the trained LLM may be used for visual content question-answering. An embodiment of using the trained LLM at inference time will be described below with reference to FIGS. 5-6.

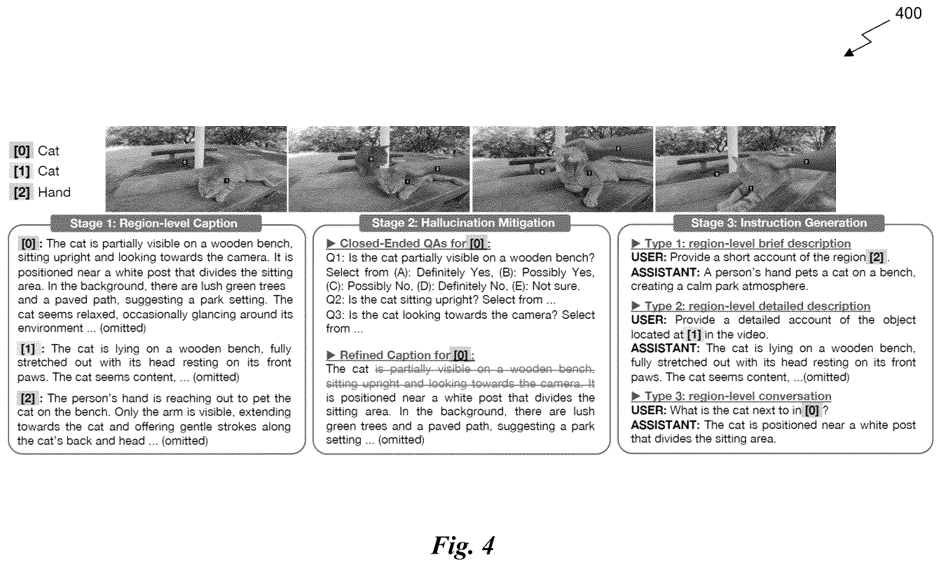

In an embodiment, the method 100 may also include generating the dataset used to train the LLM. In an embodiment, the dataset may be trained by using at least one first language model to generate region-level captions for videos paired with masklets of regions. In an embodiment, the dataset may be further generated by using at least one second language model perform multi-stage visual hallucination mitigation to refine the region-level captions. In an embodiment, the dataset may be further generated by using at least one third language model to process the refined region-level captions to generate region-level question-answer pairs. In an embodiment, the question-answer pairs and visual content with region prompt, the LLM may be trained to predict the answer from the question. In an embodiment, a cross-entropy loss may be calculated between the predicted answer and the ground-truth answer, and the LLM may be trained with an objective to minimize the loss. An embodiment of generating the training dataset will be described below with reference to FIG. 4.

Further embodiments will now be provided in the description of the subsequent figures. It should be noted that the embodiments disclosed herein with reference to the method 100 of FIG. 1 may apply to and/or be used in combination with any of the embodiments of the remaining figures below.

Embodiments described herein disclose a region-level MLLM designed for both images and videos. At the core of the framework is the use of tokens, a novel region representation that enables seamless region-level understanding across both region and text inputs. Rather than generating region embeddings from visual features, a set of tokens is predefined for use as markers to identify regions within the latent space. Given visual-text inputs paired with target region prompts (e.g., boxes or masks), a token mark is sampled and it is embedded within the spatial location defined by the region prompt. This embedding is further injected into the corresponding text prompt, allowing the LLM to directly reason the alignment between visual regions and text prompts.

This approach effectively addresses two key challenges: 1) Scalability-since each target has a unique representation shared across frames, the number of input text tokens remains independent of the number of frames, and 2) Temporal drift-representing each target as a token ensures consistent reference across frames.

Building on the use of tokens, a temporal region guide head is provided, which is an auxiliary head specifically designed for video input to address the limitations of tracking-dependent region prompts (i.e., tracklets), which are often impractical in real-world applications. Using the region prompt from the initial frame, this auxiliary head operates on the LLM's output visual tokens, classifying each visual token according to its assigned token marks. The representation of the token supports effective region guidance during training, enabling robust and consistent region understanding across frames during inference without the need for full tracklets and additional cost.

Further, the capabilities of MLLMs are heavily dependent on large-scale data. Therefore, a large-scale, diverse, and fine-grained region-level video instruction dataset is introduced. The dataset includes unique videos, with regions curated from public video datasets and region-level instruction samples. An automated pipeline is provided for curating the large-scale region-level video instruction samples based on a language model.

The LLM may be used for understanding of both image and video inputs with respect to diverse region-specific comprehension tasks, including visual commonsense reasoning, captioning, and referring expression comprehension (REC).

FIG. 2 illustrates a system pipeline 200 for training a LLM to provide visual content region-level understanding, in accordance with an embodiment. The system pipeline 200 may be implemented in hardware and/or software. The system pipeline 200 may be implemented in the context of the method 100 of FIG. 1. The descriptions and/or definitions given above may equally apply to the present embodiment.

As shown, an input image or video, defined by X∈ [symbol] ^{T×3×H}^{₀}^{×W}^{₀} (with T=1 for images), is processed by a vision encoder f(⋅), producing visual features. Through a projection layer, these visual features are then projected into visual tokens V∈ [symbol] ^{T×D×H×W}, where D is the input dimension of LLM. The visual tokens are then processed by the LLM F_{LLM}(⋅,) with a text prompt, which enables joint reasoning across textual and visual modalities.

The objective is to enable the LLM to understand specific visual elements in response to an input text prompt by incorporating N input region prompts

$${\{ {m}_{i} \}}_{i = 1}^{N} ,$$

where each mᵢ∈{0,1}^{H}^{₀}^{×W}^{₀} defines a target region (e.g., bounding box or mask). These region prompts, corresponding to a special token <region> as a placeholder in the text prompt, serve to identify and infer designated areas across the spatiotemporal dimension.

At a high-level, a set of tokens (Token Mark) are predefined, which can be thought of as different paint colors on a palette. A color is (e.g. randomly) selected to represent each target specified by the region prompt. As shown in FIG. 2 by way of example, two tokens are chosen to represent the “koala” and “person”, respectively. This color (token) is then applied to both visual and text token prompts. For visual tokens, a blank canvas is created and the selected color is applied to the specified regions, overlaying this colored canvas onto the visual tokens. For text tokens, the target placeholder (e.g., <region>) is replaced with its assigned token. Through this process, the LLM learns “where to look” during training by internalizing the predefined palette.

### Token Mark

Token Mark is defined as a set of tokens F∈ [symbol] ^{N}^{_{F}}^{×C}, where N_{F} is the total number of tokens and C denotes the feature dimension. To represent a region using Token Mark, N indices are uniformly sampled from [N_{F}] without replacement, obtaining the set of tokens

$$R = {\{ {r}_{i} \}}_{i = 1}^{N} .$$

Each sampled token rᵢ is then matched one-to-one with corresponding region prompt mᵢ so that the i-th Token Mark aligns with the i-th region prompt. These tokens serve as spatiotemporal region indicators and are injected into the language-side input for the associated visual content. Specifically, the Token Mark is projected directly into the word embedding space using a linear layer: \hat{R}=Fₚᵣₒⱼ(R)∈ [symbol] ^{N×D}.

To associate the sampled Token Mark rᵢ with its corresponding region mᵢ, the tokens are embedded into the relevant pixels defined by the region prompts. Specifically the Spatial Token Mark S∈ [symbol] ^{C×H}^{₀}^{×W}^{₀} at each pixel location (h, w) is computed per Equation 1.

$${S}_{: h , w} = \frac{{\sum }_{i = 1}^{N} {m}_{i , h , w} \cdot {r}_{i}}{ϵ + {\sum }_{i = 1}^{N} {m}_{i , h , w}} \qquad Equation 1$$

where ϵ is a small positive constant added to prevent division by zero when no masks are active at position (h, w).

Next, S is downscaled to match the shape of the visual tokens V by applying adaptive average pooling, resulting in the updated Spatial Token Mark Ŝ, which is then projected into the same feature space as \hat{R} using the shared projection layer, yielding Ŝ=Fₚᵣₒⱼ(\tilde{S})∈ [symbol] ^{D×H×W}. Finally, the spatial region-specific information is integrated into the visual tokens: \hat{V}=V+Ŝ.

This approach can enable the following:
i) Preventing temporal drift: By encoding the target region as unique representation shared across frames, the method ensures consistent region assignments throughout video sequences. This consistency distinguishes the present approach from Rol-based methods, where representations of target objects often vary across frames.
ii) Direct region-language connection: Projecting Token Mark directly within the word embedding space enables efficient modeling of region-language relationships. Unlike methods that rely on textual descriptions for each region, the present approach facilitates seamless user interaction without additional textual input for the region.
iii) Preserving vision-language global alignment: By incorporating region information as residual features, the architecture retains alignment with the base image-text pair multimodal framework (e.g., LLaVA). In cases without region prompts, the LLM functions identically to the base architecture.

FIG. 3 illustrates the temporal region guidance head of FIG. 2, in accordance with an embodiment. In the present embodiment, the temporal region guidance head is tailored for video input specifically, to allow the LLM of FIG. 2 to provide region-level understanding for a sequence of frames in a video.

For video input, an auxiliary head is introduced to the pipeline of FIG. 2 during training to enhance region consistency across frames, ensuring an accurate representation of regions even when a region prompt is provided for only the first frame. This auxiliary head classifies the corresponding Token Mark for each visual token, implicitly guiding the model to understand the target region without relying on explicit video object correspondence from tracklets.

Let Vₜ represent the visual tokens at the t-th frame, forming a sequence of visual tokens for the entire video, denoted as V_{vid}=(\hat{V}₁, V₂, . . . , V_{T}), where \hat{V}₁ contains the target region information. The sequence V_{vid} is then processed by the language model, which aims to generate region-aware predictions for the entire video sequence.

The auxiliary classification head Fₐᵤₓ performs per Equation 2.

$${F}_{a u x} ( {F}_{L L M} ( {V}_{vid} ) ) ∈ {T \times H \times W \times ( {N}_{F} + 1 )}^{} \qquad Equation 2$$

where N_{F}+1 is classification categories (the N_{F} Token Mark and the background).

Since the visual tokens are downscaled from the original input resolution, multiple Token Marks may exist within a single visual token. To handle this, we soft-label classification is applied, assigning each token a soft-label distribution over the N_{F}+1 categories to reflect the proportion of each token belonging to multiple regions or the background.

### Loss Function

The final loss is defined as [symbol] = [symbol] _{LLM}+α [symbol] ₐᵤₓ, where α balances the contribution of the auxiliary classification loss. The language model loss, [symbol] _{LLM}, is computed as the cross-entropy loss between the predicted tokens and the ground truth tokens. Meanwhile, the auxiliary classification loss, [symbol] ₐᵤₓ, is defined as the cross-entropy loss between the predicted soft-label distributions and the ground truth soft-label distributions for each visual token. This region guide head is used only during training and does not introduce additional latency during inference.

FIG. 4 illustrates an instruction sample generation process 400, in accordance with an embodiment. The process 400 may be implemented for generating the training dataset used for the training pipeline 200 of FIG. 2.

The present process 400 generates a region-level video instruction dataset, which can enhance the LLM's dialog capability and obtain accurate responses about the regions in the videos. The process consists of three-steps, i) GPT4o-assisted region-level detailed captioning, ii) visual hallucination mitigation, and iii) caption-guided region-level instruction sample generation.

The key characteristics of the dataset are i) large-scale: the dataset consists of 98 k unique videos, 214 k tracklets or masklets, and 294 k instructions, such as region-level detailed captioning, conversations, ii) diverse: the videos are collected from 10 public datasets used in different tasks, iii) fine-grained QAs: each region is described within about 60 words, including contextual and temporal information of the regions, resulting in diverse instruction samples, and iv) high-fidelity: the visual hallucinations in detailed captions are mitigated.

### Data Collection

The videos are collected from public datasets that contain annotated regions (e.g., masklets, tracklets, or a single frame bounding box) along with nouns.

### GPT4o-Assisted Region-level Captions

From paired videos and masklets of regions, the visual prompting technique of set-of-mark (SOM) is adapted to overlay object masks with region indices at the center of each mask for every frame in the video. The SOM-processed videos are then input into GPT4o, requesting enriched captions by including contextual and temporal information of each masklet from nouns in text prompts, such as “Generate the detailed description of [0]: cat, [1]: cat, [2]: hand”.

### Visual Hallucination Mitigation

The visual hallucination in the generated captions are mitigated to improve the fidelity. Although the region-level captions generated by GPT4o contain fine-grained information, the synthetically generated detailed captions contain visual hallucinations, and it is crucial to mitigate these to generate high-fidelity instruction samples.

Multi-stage visual hallucination mitigation is applied using LLMs and MLLMs. First, detailed region-level captions are decomposed into multiple closed ended questions that ask about the contents in the captions using LLMs. Then, these questions are input into MLLMs along with videos to validate whether the content is correct. In the third stage, the questions not verified in the previous step are gathered and LLMs are asked to remove the unverified contents in the original captions and re-generate them.

### GPT-Assisted Region-level Instruction Data

In the final step, the captions are further processed to generate region-level video instructions. Text-only GPT4 is used to create region-specific question-answer pairs from the detailed captions, addressing various aspects of the captions. The samples include detailed descriptions, summaries, and general QAs for the specific regions. A few in-context examples are provided to enhance the quality of sample generation. The generated instructions cover both contextual (e.g., color, spatial positions) and temporal aspects (e.g., motions, actions).

FIG. 5 illustrates a method 500 for using an LLM to provide visual content region-level understanding, in accordance with an embodiment. The LLM may be the LLM trained per the pipeline 200 of FIG. 2.

In operation 502, a visual content, a text prompt referring to a visual element in the visual content, and a region prompt defining the visual element are received as input. In an embodiment, the visual content may be an image. In another embodiment, the visual content may be a video (e.g. with the region prompt provided for an initial frame of the video).

In an embodiment, the text prompt may be a question that refers to the visual element in the visual content. In an embodiment, the text prompt may be an instruction to generation a caption for the visual element in the visual content. In an embodiment, the text prompt may be an instruction to perform referring expression comprehension (REC) for the visual element in the visual content.

In operation 504, the input is processed, by an LLM, to generate a textual output. In an embodiment, the output may be a text answer to the question included in the text prompt. In an embodiment, the output may be a caption for the visual element. In an embodiment, the output may be a bounding box or other region-specific identifier of the visual element in the visual content.

In operation 506, the output is presented. In an embodiment, the output may be presented on a display device (e.g. with the visual content). In an embodiment, the output may be presented as an input to a downstream task (e.g. application).

FIG. 6 illustrates visual examples of the input and output of the method of FIG. 5, in accordance with an embodiment. Given user-defined localized region inputs (boxes or masks) for a visual content accompanied by a corresponding text prompt, the LLM generates responses tailored to the visual context of each region of the visual content.

In a first example shown, the LLM is used for region-level captioning of an image. In a second example shown, the LLM is used for region-level equation-answer (QA) with respect to an image. In a third example shown, the LLM is used for region-level captioning of a video. In a fourth example shown, the LLM is used for region-level QA with respect to a video.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

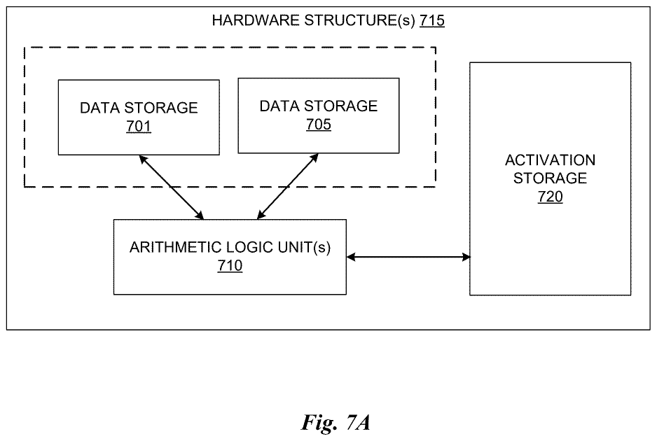

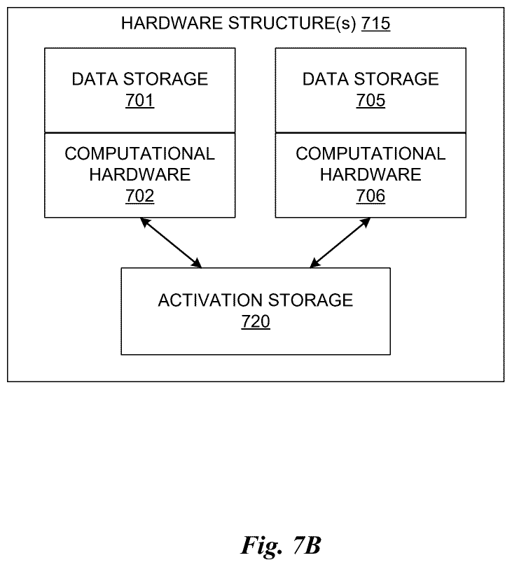

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

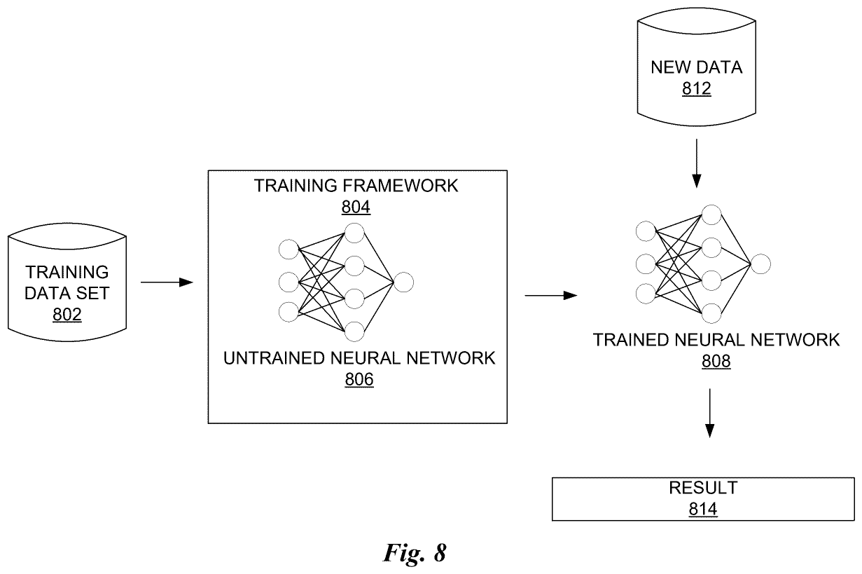

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

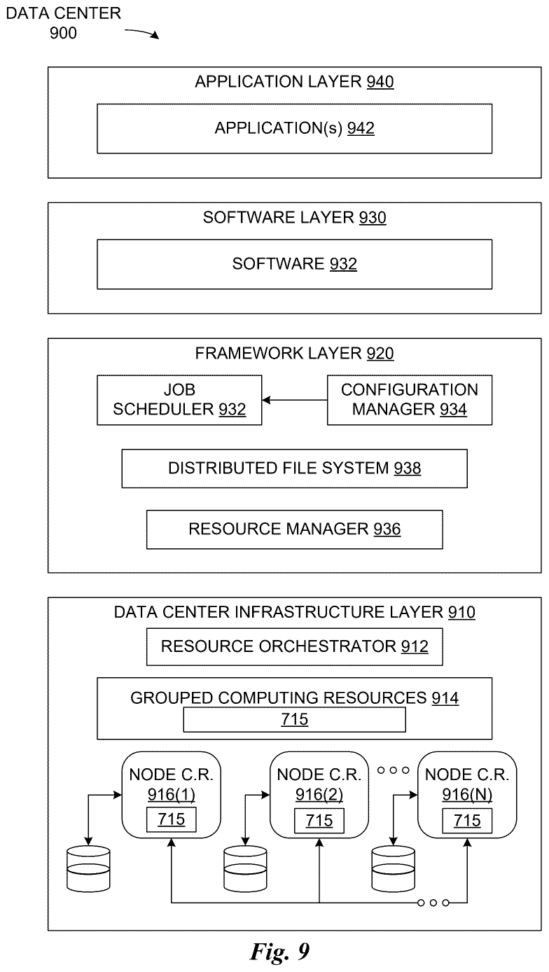

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to train an LLM. In accordance with FIGS. 1-6, embodiments may provide a LLM for performing inferencing operations and for providing inferenced data. The LLM may be stored (partially or wholly) in one or both of data storage 701 and 705 in inference and/or training logic 715 as depicted in FIGS. 7A and 7B. Training and deployment of the LLM may be performed as depicted in FIG. 8 and described herein. Distribution of the LLM may be performed using one or more servers in a data center 900 as depicted in FIG. 9 and described herein.

What is claimed is:

1. A method, comprising:
at a device:
accessing a dataset of prompt pairs for a visual content, each of the prompt pairs including a region prompt that defines a target region within the visual content and a text prompt that describes the target region within the visual content; and
training a large language model (LLM) to provide visual content region-level understanding, using the dataset, including for each prompt pair of at least a subset of the prompt pairs included in the dataset:
sampling a predefined token from a set of predefined tokens to represent the target region within the visual content,
using the predefined token to form a correspondence between the target region within the visual content and the text prompt, and
learning by the LLM an alignment between the target region within the visual content and the text prompt, based on the correspondence.

2. The method of claim 1, wherein the visual content is an image.

3. The method of claim 1, wherein the visual content is a frame of a video.

4. The method of claim 1, wherein the region prompt is a bounding box defining the target region within the visual content.

5. The method of claim 1, wherein the region prompt is a mask defining the target region within the visual content.

6. The method of claim 1, wherein the target region corresponds to a visual element in the visual content and wherein the text prompt includes at least one noun that names the visual element.

7. The method of claim 1, wherein the visual content region-level understanding includes the LLM understanding a visual element in a given visual content in response to a given text prompt referring to the visual element and a given region prompt defining the visual element.

8. The method of claim 1, wherein using the predefined token to form a correspondence between the target region within the visual content and the text prompt includes:
associating the predefined token with both the target region within the visual content and the text prompt.

9. The method of claim 8, wherein associating the predefined token with the target region within the visual content includes:
embedding the predefined token into pixels included in the target region within the visual content.

10. The method of claim 8, wherein associating the predefined token with the text prompt includes:
injecting the predefined token into the text prompt.

11. The method of claim 1, wherein when the visual content is a frame of video, then training the LLM further includes:
generating region-aware predictions for a sequence of frames in the video.

12. The method of claim 1, further comprising, at the device:
generating the dataset by:
using at least one first language model to generate region-level captions for videos paired with masklets of regions.

13. The method of claim 12, wherein the dataset is further generated by:
using at least one second language model perform multi-stage visual hallucination mitigation to refine the region-level captions.

14. The method of claim 13, wherein the dataset is further generated by:
using at least one third language model to process the refined region-level captions to generate region-level question-answer pairs.

15. The method of claim 1, further comprising, at the device:
deploying the trained LLM.

16. The method of claim 15, wherein the trained LLM is executed to textually describe a visual element in a given visual content in response to a given text prompt referring to the visual element and a given region prompt defining the visual element.

17. The method of claim 16, wherein the given visual content is an image.

18. The method of claim 16, wherein the given visual content is a video.

19. The method of claim 15, wherein the trained LLM is used for visual content captioning.

20. The method of claim 15, wherein the trained LLM is used for visual content question-answering.

21. A system, comprising:
a non-transitory memory comprising instructions; and
one or more processors in communication with the non-transitory memory, wherein the one or more processors execute the instructions to:
access a dataset of prompt pairs for a visual content, each of the prompt pairs including a region prompt that defines a target region within the visual content and a text prompt that describes the target region within the visual content; and
train a large language model (LLM) to provide visual content region-level understanding, using the dataset, including for each prompt pair of at least a subset of the prompt pairs included in the dataset:
sampling a predefined token from a set of predefined tokens to represent the target region within the visual content,
using the predefined token to form a correspondence between the target region within the visual content and the text prompt, and
learning by the LLM an alignment between the target region within the visual content and the text prompt, based on the correspondence.

22. The system of claim 21, wherein the visual content region-level understanding includes the LLM understanding a visual element in a given visual content in response to a given text prompt referring to the visual element and a given region prompt defining the visual element.

23. The system of claim 21, wherein the one or more processors further execute the instructions to:
deploy the trained LLM,
wherein the trained LLM is executed to textually describe a visual element in a given visual content in response to a given text prompt referring to the visual element and a given region prompt defining the visual element.

24. The system of claim 23, wherein the given visual content is an image.

25. The system of claim 23, wherein the given visual content is a video.

26. A non-transitory computer-readable media storing computer instructions which when executed by one or more processors of a device cause the device to:
access a dataset of prompt pairs for a visual content, each of the prompt pairs including a region prompt that defines a target region within the visual content and a text prompt that describes the target region within the visual content; and
train a large language model (LLM) to provide visual content region-level understanding, using the dataset, including for each prompt pair of at least a subset of the prompt pairs included in the dataset:
sampling a predefined token from a set of predefined tokens to represent the target region within the visual content,
using the predefined token to form a correspondence between the target region within the visual content and the text prompt, and
learning by the LLM an alignment between the target region within the visual content and the text prompt, based on the correspondence.

27. The non-transitory computer-readable media of claim 26, wherein the visual content region-level understanding includes the LLM understanding a visual element in a given visual content in response to a given text prompt referring to the visual element and a given region prompt defining the visual element.

28. The non-transitory computer-readable media of claim 26, wherein the one or more processors further execute the instructions to:
deploy the trained LLM,
wherein the trained LLM is executed to textually describe a visual element in a given visual content in response to a given text prompt referring to the visual element and a given region prompt defining the visual element.

29. The non-transitory computer-readable media of claim 28, wherein the given visual content is an image.

30. The non-transitory computer-readable media of claim 28, wherein the given visual content is a video.
